(19) United States
(12) Patent Application Publication
(10) Pub. No.: US 2020/0297136 A1
(43) Pub. Date: Sep. 24, 2020

(54) Drinking Container Convertible into a Whistling Device

(71) Applicant: Ultimate-Fan Bottle Inc., Montréal (CA)

(72) Inventors: Antoine Bécotte, Montréal (CA); Norman Bédard, Saint-Joseph-de-Coleraine (CA)

(21) Appl. No.: 16/755,363

(22) PCT Filed: Oct. 12, 2018
(86) PCT No.: PCT/CA2018/051288

§ 371 Date: Apr. 10, 2020

Related U.S. Application Data
(60) Provisional application No. 62/571,566, filed on Oct. 12, 2017.

(51) Int. Cl. A47G 19/22; B65D 1/02; B65D 81/36; G10K 5/00

(52) U.S. Cl. CPC A47G 19/2227; B65D 1/02; A47G 2019/2244; G10K 5/00; B65D 81/36

(57) ABSTRACT

A drinking container configurable between a drinking configuration and a whistling configuration. The drinking container comprise a main portion defining a liquid receiving cavity and a whistling portion positioned below the main portion and operatively connected thereto. The whistling portion comprises a whistle and is translatable relative to the main portion to configure the drinking container between the drinking configuration and the whistling configuration. When the drinking container is configured in the drinking configuration, a section of the liquid receiving cavity is sealed and prevents fluid communication between the liquid receiving cavity and the whistle while allowing the liquid receiving cavity to hold a liquid therein When the drinking container is configured in the whistling configuration, the section of the liquid receiving cavity is unsealed and allows fluid communication between the liquid receiving cavity and the whistle.

### CROSS-REFERENCE TO RELATED APPLICATIONS

This application claims priority under 35 USC § 119(e) of U.S. provisional patent application(s) 62/571,566 filed on Oct. 12, 2017, the specification(s) of which is hereby incorporated by reference.

### TECHNICAL FIELD OF THE INVENTION

The present invention relates to the field of drinking containers. More particularly, it relates to a drinking container convertible into a whistling device and to a corresponding method for converting the drinking container into the whistling device.

### BACKGROUND

In a plurality of events, such as sporting events, concerts or the like, beverages are sold in drinking containers for users to consume while enjoying the event. With conventional drinking containers, the containers are usually discarded by the users once the beverage held in the container has been consumed.

At such events, users also often want to produce loud noises, for example and without being limitative, to support one of the playing teams, show their appreciation of the event, manifest their approval/disapproval, etc. In order to do so, users either need to bring a noise producing device such as, for example and without being limitative, a horn, a whistle, a rattle, etc., or use the available options such as clapping their hands, stomping their feet, using their mouth to shout or whistle, banging their seat, etc.

However as, mentioned above, common drinking containers are usually limited in their use to the consumption of the beverage held therein and cannot easily be converted to produce a whistling sound loud enough to be used as a whistling device for loud crowds, when a user blows in the closed container.

In view of the above, there is a need for an improved drinking container convertible into a whistling device and method for converting the drinking container into the whistling device which would be able to overcome, or at least minimize, some of the above-discussed prior art concerns.

### BRIEF SUMMARY OF THE INVENTION

In accordance with a first general aspect, there is provided a drinking container configurable between a drinking configuration and a whistling configuration. The drinking container comprise a main portion defining a liquid receiving cavity and a whistling portion positioned below the main portion and operatively connected thereto. The whistling portion comprises a whistle and is translatable relative to the main portion to configure the drinking container between the drinking configuration and the whistling configuration. When the drinking container is configured in the drinking configuration, a section of the liquid receiving cavity is sealed and prevents fluid communication between the liquid receiving cavity and the whistle while allowing the liquid receiving cavity to hold a liquid therein When the drinking container is configured in the whistling configuration, the section of the liquid receiving cavity is unsealed and allows fluid communication between the liquid receiving cavity and the whistle.

In an embodiment, the drinking container includes a translation assembly configured to allow the translation of the whistling portion relative to the main portion, for transitioning the drinking container between the drinking configuration and the whistling configuration.

In an embodiment, the whistling portion is rotatably mounted to the main portion. The whistling portion is translatable to configure the drinking container between the drinking configuration and the whistling configuration by a rotation thereof relative to the main portion.

In an embodiment, one of the main portion and the whistling portion comprises at least one elongated guiding slot, and the other one of the main portion and the whistling portion comprises at least one projection engageable in a corresponding one of the at least one guiding slot to allow rotation between the main portion and the whistling portion.

In an embodiment, the main portion and the whistling portion include complementary threads to allow rotation between the main portion and the whistling portion.

In an embodiment, the drinking container further comprises a security tab selectively preventing translation of the whistling portion relative to the main portion and thereby selectively preventing the drinking container from being moved from the drinking configuration to the whistling configuration.

In an embodiment, the main portion comprises a peripheral wall section being open at a lower end thereof and the whistling portion comprises an upper wall and a sealing member. The sealing member is pressed against the peripheral wall section of the main portion to seal the section of the liquid receiving cavity using the upper wall of the whistling portion, when the drinking container is configured in the drinking configuration.

In an embodiment, the sealing member projects from the upper wall of the whistling portion, at a periphery thereof.

In an embodiment, the whistling portion is translatable away from the main portion to space the sealing member from the peripheral wall section of the main portion and unseal the liquid receiving cavity to configure the drinking container in the whistling configuration.

In an embodiment, the peripheral wall section of the main portion comprises an abutment shoulder and the sealing member of the whistling portion is pressed against the abutment shoulder of the peripheral wall section of the main portion, when the drinking container is configured in the drinking configuration.

In an embodiment, the whistling portion comprises an outer section having a side wall engageable to a section of the peripheral wall section of the main portion and an inner section including the upper wall of the whistling portion and a side wall having at least one through hole extending therethrough.

In an embodiment, the outer section of the whistling portion comprises a whistle receiving protrusion having an upper wall with a whistling aperture defined therein and extending therethrough. The whistle receiving protrusion defines a hollow inner space for receiving the whistle. When the drinking container is configured in the whistling configuration, the spacing of the sealing member apart from the peripheral wall section of the main portion allows fluid communication between the liquid receiving cavity and the hollow inner space of the whistle receiving protrusion.

In an embodiment, the main portion comprises a unitary wall having an unperforated bottom wall section when the drinking container is configured in the drinking configuration and the whistling portion engages the unperforated wall section of the main portion to perforate the bottom wall section of the main portion when the drinking container is configured in the drinking configuration.

In an embodiment, the whistling portion comprises a perforation assembly and a whistle receiving protrusion having an upper wall with a whistling aperture defined therein and extending therethrough. The whistle receiving protrusion defines a hollow inner space for receiving the whistle. When the drinking container is configured in the whistling configuration, the perforation assembly perforates the unperforated wall section of the main portion and allows fluid communication between the liquid receiving cavity and the hollow inner space of the whistle receiving protrusion.

In an embodiment, the perforation assembly comprises a cutting member extending from the upper wall of the whistle receiving protrusion.

In an embodiment, the perforation assembly comprises a spreading flange extending from the upper wall of the whistle receiving protrusion along a periphery of the whistling aperture.

In an embodiment, the whistling portion comprises an inner cavity and a sealing shoulder extending in the inner cavity of the whistling portion. The sealing shoulder is abuttable against a surface of the main portion when the drinking container is configured in the whistling configuration to seal a section of the inner cavity of the whistling portion.

In an embodiment, the main portion comprises a lower flange extending peripherally at the lower end thereof. The sealing shoulder is abuttable with a lower end of the lower flange when the drinking container is configured in the whistling configuration.

In an embodiment, at least one of the whistling portion and the main portion further comprises a resilient sealing member projecting from a corresponding one of the sealing shoulder and the lower flange.

In accordance with another general aspect, there is also provided a drinking container configurable between a drinking configuration and a whistling configuration. The drinking container comprises a main portion having a peripheral wall defining a liquid receiving cavity with the peripheral wall being open at a lower end thereof and a whistling portion positioned below the main portion and operatively connected thereto. The whistling portion comprises an upper wall operatively engaged to a section of the peripheral wall of the main portion to seal a lower section of the liquid receiving cavity and prevent fluid communication between the liquid receiving cavity and the whistle, when the drinking container is configured in the drinking configuration. The upper wall is disengaged from the section of the peripheral wall of the main portion to unseal the lower section of the liquid receiving cavity and allow fluid communication between the liquid receiving cavity and the whistle, when the drinking container is configured in the whistling configuration.

In an embodiment, the drinking container includes a translation assembly configured to allow the translation of the whistling portion relative to the main portion, for transitioning the drinking container between the drinking configuration and the whistling configuration.

In an embodiment, the whistling portion is rotatably mounted to the main portion. The whistling portion is translatable to configure the drinking container between the drinking configuration and the whistling configuration by a rotation thereof relative to the main portion.

In an embodiment, one of the main portion and the whistling portion comprises at least one elongated guiding slot, and the other one of the main portion and the whistling portion comprises at least one projection engageable in a corresponding one of the at least one guiding slot to allow rotation between the main portion and the whistling portion.

In an embodiment, the main portion and whistling portion include complementary threads to allow rotation between the main portion and the whistling portion.

In an embodiment, the whistling portion includes a sealing member projecting from the upper wall of the whistling portion, at a periphery thereof. The sealing member is pressed against the section of the peripheral wall of the main portion to operatively engage the upper wall of the whistling portion with the section of the peripheral wall of the main portion and seal the lower section of the liquid receiving cavity, when the drinking container is configured in the drinking configuration.

In an embodiment, the whistling portion is translatable away from the main portion to space the sealing member from the section of the peripheral wall of the main portion and unseal the lower section of the liquid receiving cavity to configure the drinking container in the whistling configuration.

In an embodiment, the section of the peripheral wall of the main portion comprises an abutment shoulder and the sealing member of the whistling portion is pressed against the abutment shoulder of the section of the peripheral wall of the main portion, when the drinking container is configured in the drinking configuration.

In an embodiment, the whistling portion comprises an outer section having a peripheral wall engageable to the peripheral wall of the main portion and an inner section including the upper wall of the whistling portion and a side wall having at least one through hole extending therethrough.

In an embodiment, the outer section of the whistling portion comprises a whistle receiving protrusion having an upper wall with a whistling aperture defined therein and extending therethrough, the whistle receiving protrusion defining a hollow inner space for receiving the whistle. When the drinking container is configured in the whistling configuration, the spacing of the sealing member apart from the section of the peripheral wall of the main portion allows fluid communication between the liquid receiving cavity and the hollow inner space of the whistle receiving protrusion.

In accordance with another general aspect, there is also provided a method for configuring a drinking container between a drinking configuration and a whistling configuration. The drinking container has a main portion sized and shaped to define a liquid receiving cavity and a whistling portion including a whistle and operatively connected to the main portion. The method comprises: receiving the drinking container in the drinking configuration wherein a section of the liquid receiving cavity is sealed to prevent fluid communication between the liquid receiving cavity and the whistle and to allow the liquid receiving cavity to hold a liquid; emptying the liquid from the liquid receiving cavity of the main portion of the drinking container; and translating the whistling portion relative to the main portion until the section of the liquid receiving cavity is unsealed and the main portion and the whistle of the whistling portion are in fluid communication.

In an embodiment, the step of translating the whistling portion relative to the main portion comprises rotating the whistling portion relative to the main portion.

In an embodiment, the whistling portion comprises an upper wall operatively engaged to a peripheral wall of the main portion to seal the section of the liquid receiving cavity when the drinking container is configured in the drinking configuration. The step of translating the whistling portion relative to the main portion until the liquid receiving cavity is unsealed further comprises disengaging the upper wall from the peripheral wall of the main portion to unseal the corresponding section of the liquid receiving cavity.

In an embodiment, the main portion comprises a unitary wall having an unperforated lower wall section and the whistling portion includes a perforation assembly and a whistle receiving protrusion having an upper wall with a whistling aperture defined therein and extending therethrough, the whistle receiving protrusion defining a hollow inner space for receiving the whistle. The step of translating the whistling portion relative to the main portion until the liquid receiving cavity is unsealed further comprises perforating the unperforated lower wall section of the main portion to allow fluid communication between the liquid receiving cavity and the hollow inner space of the whistle receiving protrusion.

### BRIEF DESCRIPTION OF THE DRAWINGS

Other objects, advantages and features will become more apparent upon reading the following non-restrictive description of embodiments thereof, given for the purpose of exemplification only, with reference to the accompanying drawings in which:

FIGS. 1A to 1C are perspective views of a drinking container in accordance with an embodiment, wherein the container is shown in a drinking configuration, and respectively showing the drinking container with a security tab secured thereto (A), the security tab partially removed (B) and the security tab completely removed (C).

FIG. 2 is a cross sectional view of a lower portion of the drinking container of FIG. 1A, in the drinking configuration, and taken along line 2-2 on FIG. 1A.

FIG. 3 is a perspective view of the drinking container of FIG. 1A, shown in the whistling configuration.

FIG. 4 is a cross sectional view of a lower portion of the drinking container of FIG. 3, in the whistling configuration, and taken along line 4-4 on FIG. 3.

FIG. 5 is a perspective view of the drinking container of FIG. 3, in the whistling configuration, shown with a cross-section of an upper portion of the main portion of the drinking container taken along line 5-5 removed.

FIG. 6 is a perspective view of the main portion of the drinking container of FIG. 1A.

FIGS. 7A and 7B are perspective views, respectively from above and from below, of the whistling portion of the drinking container of FIG. 1A.

FIG. 8 is a front elevation view of a drinking container in accordance with an alternative embodiment and shown in the drinking configuration.

FIG. 9A is a cross sectional view of a lower portion of the drinking container of FIG. 8, in the drinking configuration.

FIG. 9B is a cross sectional view of a lower portion of the drinking container of FIG. 8, in the whistling configuration.

FIG. 10 is a perspective view of an air permeable inner section of the whistling portion of the drinking container of FIG. 8.

FIG. 11 is a perspective view of an outer section of the whistling portion of the drinking container of FIG. 8.

### DETAILED DESCRIPTION

In the following description, the same numerical references refer to similar elements. The embodiments, geometrical configurations, materials mentioned and/or dimensions shown in the figures or described in the present description are embodiments only, given solely for exemplification purposes.

Moreover, although the embodiments of the drinking container convertible into a whistling device and corresponding parts thereof consist of certain geometrical configurations as explained and illustrated herein, not all of these components and geometries are essential and thus should not be taken in their restrictive sense. It is to be understood, as also apparent to a person skilled in the art, that other suitable components and cooperation thereinbetween, as well as other suitable geometrical configurations, may be used for the drinking container convertible into a whistling device, as will be briefly explained herein and as can be easily inferred herefrom by a person skilled in the art. Moreover, it will be appreciated that positional descriptions such as “above”, “below”, “left”, “right” and the like should, unless otherwise indicated, be taken in the context of the figures and should not be considered limiting.

As will be better understood in view of the detailed description below, the drinking container 10 described herein is a container designed to be configurable between a drinking configuration in which the drinking container 10 can hold a liquid (similarly to conventional drinking containers such as, without being limitative, sport drink bottles, juice bottles, water bottles, beer cans, soda cans or the like) and a whistling configuration in which the drinking container 10 can be used as a whistling device, to produce a loud whistling sound.

In the course of the present document, the term “whistle” is used to refer to any device used to produce a sound through the passage of air in a cavity thereof, against a thin edge thereof, or the like.

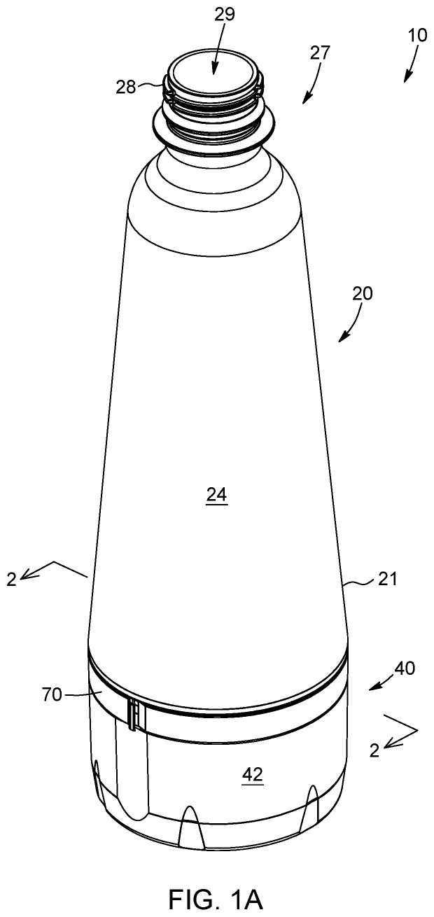

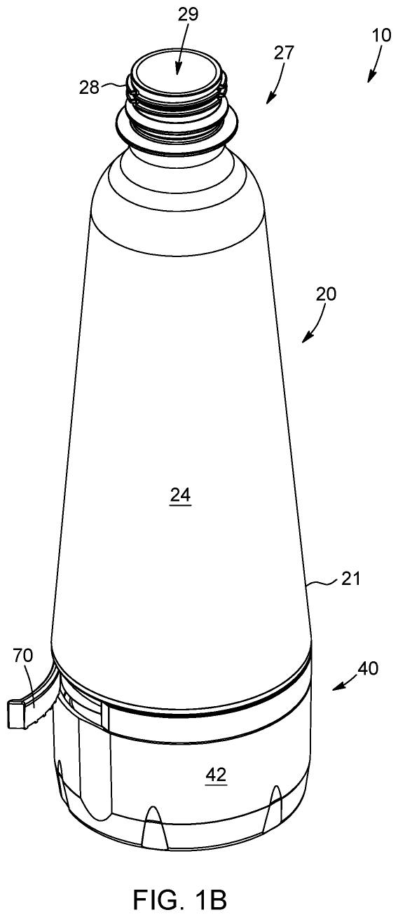

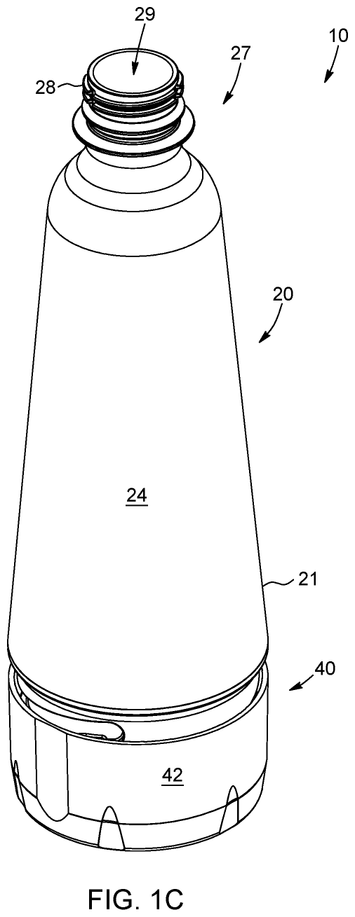

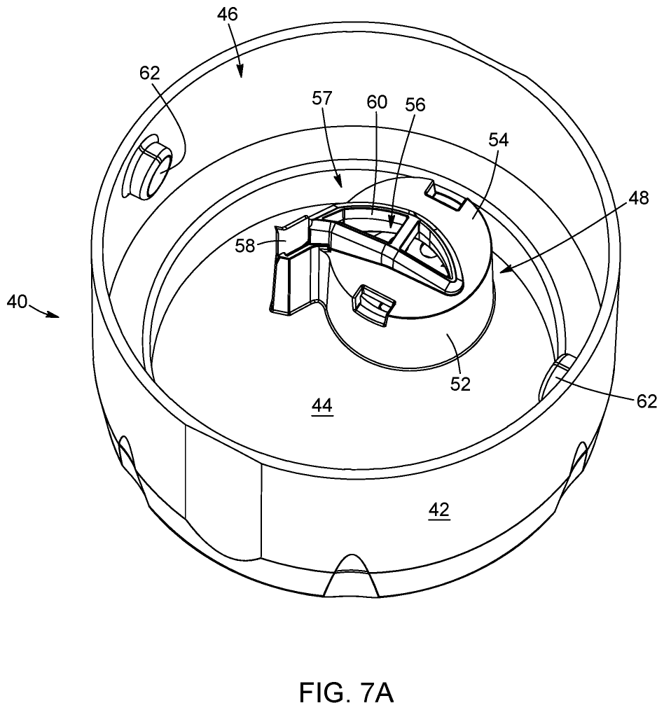

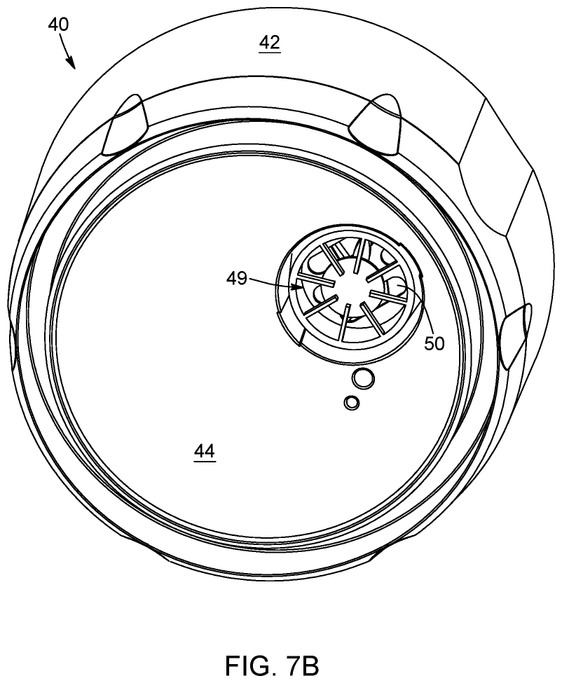

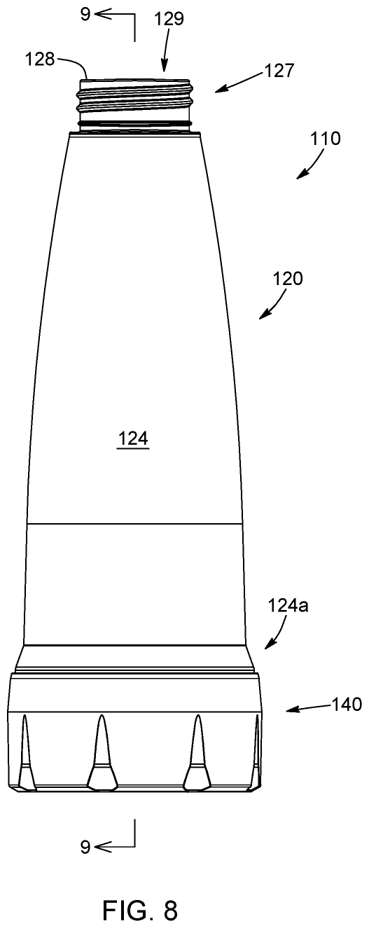

A first embodiment of the drinking container 10 is shown in FIGS. 1A to 7B. An alternative embodiment of the drinking container 110, wherein similar features are numbered using similar reference numerals to the first embodiment, but in the 100 series, is shown in FIGS. 8 to 11. Each one of the embodiments shown in the Figures and described in detail below concerns a drinking container 10, 110, which allows the above-mentioned transition between the drinking configuration in which the drinking container 10, 110 can hold a liquid therein (and allow easy consumption of the liquid by a user) and the whistling configuration in which the drinking container 10, 110 can be used as a whistling device.

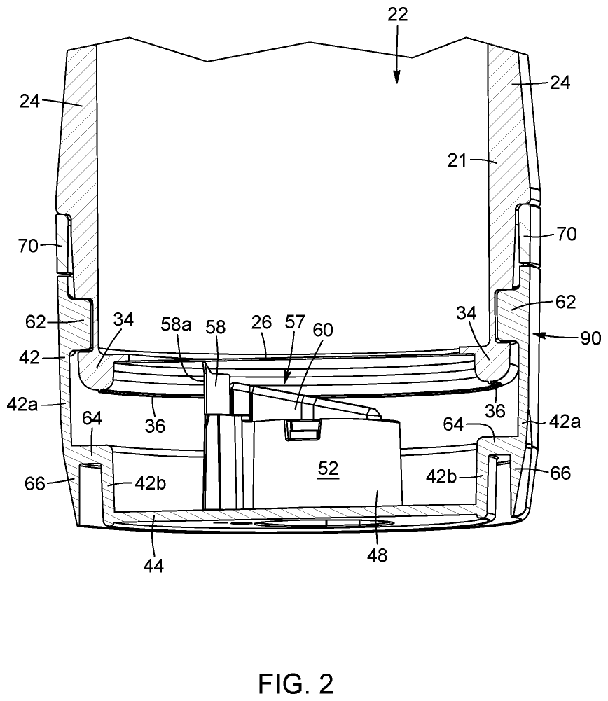

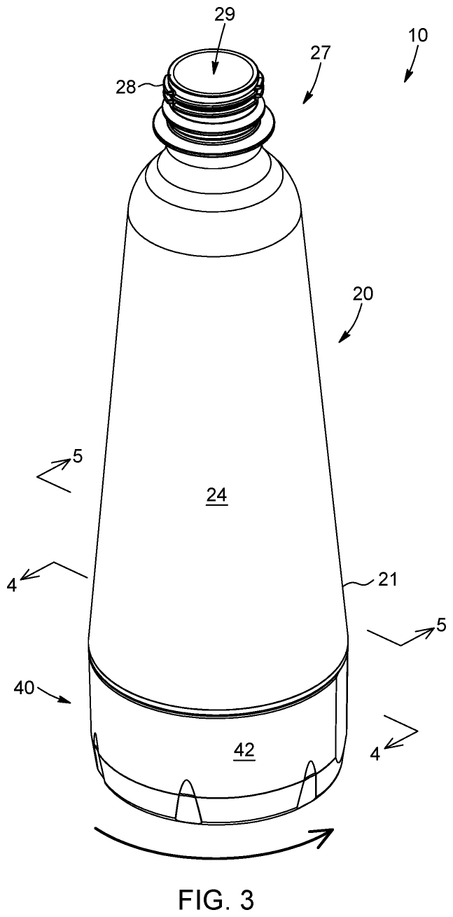

Referring to FIGS. 1A to 7B, the drinking container 10 in accordance with one embodiment is shown and will be described in detail below. The drinking container 10 includes a main portion 20 and a whistling portion 40 operatively connected (or mounted) to the main portion 20. In the embodiment shown, the whistling portion 40 is positioned below the main portion 20 and is translatable (i.e. displaceable) relative to the main portion 20 to move the drinking container 10 between the drinking configuration (see FIGS. 1A to 1C and 2) and the whistling configuration (see FIGS. 3 to 5), as will be described in more details below.

Referring to FIGS. 1A to 6, in the embodiment shown, the main portion 20 defines a liquid receiving cavity 22. The main portion 20 has a unitary wall 21 defining the liquid receiving cavity 22, with a peripheral wall section 24, a bottom wall section 26 and a closeable upper end 27. In the drinking configuration, the bottom section of the liquid receiving cavity 22 is sealed by the unitary wall 21 to prevent fluid communication between the liquid receiving cavity 22 and a whistle 50, as will be described in more details below. Therefore, the main portion 20 can receive and temporarily hold a liquid, such as water, juice, soft drink, beer or the like, in the liquid receiving cavity 22 thereof, for consumption of the liquid by a user. In the embodiment shown, the closeable upper end 27 of the unitary wall 21 includes a bottleneck 28 with an upper opening 29 at an upper end thereof. In the embodiment shown, the bottleneck 28 has a threaded outer surface allowing a removable threaded screw cap (not shown) to be selectively screwed onto the drinking container 10 to close the liquid receiving cavity 22 and prevent the liquid contained therein to leak out of the liquid receiving cavity 22 through the upper opening 29. One skilled in the art will understand that, in alternative embodiments, the bottleneck 28 could rather have a threaded inner surface allowing a removable threaded screw cap (not shown) to be selectively screwed onto the drinking container 10. Moreover, in alternative embodiments. (not shown), the upper opening 29 of the bottleneck 28 can also be closed by a closing member different from a screw cap, such as, without being limitative, a flip-top cap, a sports cap, a friction fit cap, or any other member capable of temporarily closing the upper opening 29. Furthermore, in other alternative embodiments (not shown), the closeable upper end 27 can also include an assembly different than the above described bottleneck and screw cap for temporarily closing the liquid receiving cavity 22. For example and without being limitative, in an embodiment (not shown), the liquid receiving cavity 22 can be shaped similarly to beverage cans (such as cans commonly used for beer, soft drink or the like) with a pop-top upper opening.

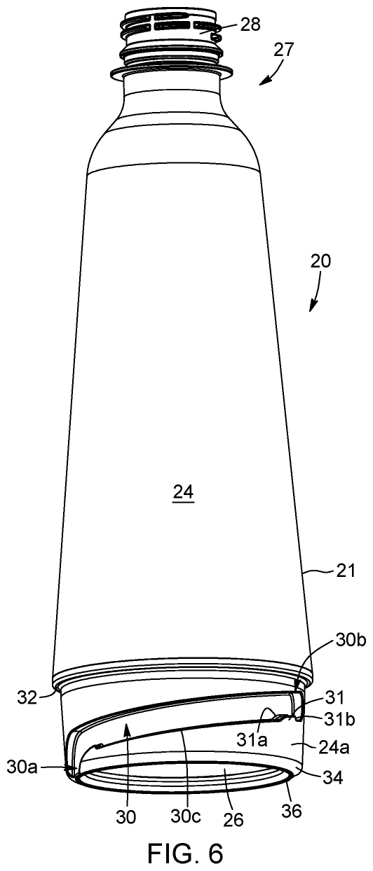

As can be seen more clearly in FIGS. 2 and 6, in an embodiment, a lower section 24a of the peripheral wall section 24 of the unitary wall 21 of the main portion 20 is recessed inwardly, thereby defining an abutment shoulder 32 at an upper end of the lower section 24a. In an embodiment, the main portion 20 also includes a lower flange 34, extending peripherally at the lower end thereof, with the bottom wall section 26 being inwardly recessed therefrom. In an embodiment, the main portion 20 further includes a sealing member 36 extending downwardly from the lower end of the lower flange 34. In the embodiment shown, the sealing member 36 is a lip projecting downwardly from the lower end of the lower flange 34 and is made of the same material as the remaining of the main portion 20. One skilled in the art will however understand that, in an alternative embodiment (not shown), the sealing member 36 could be made of resilient material, such as rubber, silicon, or the like, in order to present high sealing properties when abutted against a rigid surface. One skilled in the art will also understand that, in alternative embodiments (not shown), the lower section 24a of the peripheral wall section 24 can be substantially evenly levelled with the remaining of the peripheral wall section 24, such that no abutment shoulder is defined between the lower section 24a of the peripheral wall section 24 and the remaining of the peripheral wall section 24 and /or the main portion 20 can be free of lower peripheral flange 34 and/or sealing member 36, with the bottom wall section 26 therefore not being inwardly recessed from the lower end of the main portion 20 of the drinking container 10.

The lower section 24a of the peripheral wall section 24 is operatively connectable with the whistling portion 40, as will be described in more details below. In the embodiment shown, the lower section 24a of the peripheral wall section 24 includes elongated guiding slots 30 defined on an outer surface thereof. As will be described in more details below, the elongated guiding slots 30 are a component of a translation assembly 90, which allows the translation of the whistling portion 40 relative to the main portion 20, for the drinking container 10 to be configured between the drinking configuration and the whistling configuration. Each one of the elongated guiding slots 30 includes a lower end 30a and an upper end 30b and extends along a length of the outer surface of the lower section 24a of the peripheral wall section 24. Each one of the elongated guiding slots 30 is upwardly angled, to allow the translation of the whistling portion 40 relative to the main portion 20, when the drinking container 10 is moved from the drinking configuration to the whistling configuration, as will be described in more details below. In the course of the present description, the term “upwardly angled” is understood to mean that the upper end 30b of the guiding slot 30 is located above the lower end 30a thereof on the unitary wall 21 when the drinking container is positioned in an upright orientation (see FIG. 6) (or closer to the upper end 27 of the unitary wall 21 than the lower end 30a).

Now referring to FIGS. 1A to 5, 7A and 7B, the whistling portion 40 of the drinking container 10 includes a side wall 42 and a bottom wall 44 together defining an inner cavity 46 of the whistling portion 40. In an embodiment, the side wall 42 includes a lower section 42b inwardly recessed from an upper section 42a thereof. The inward recess of the lower section 42b of the side wall 42 defines a sealing shoulder 64, extending between the lower section 42b and the upper section 42a of the side wall 42. In the embodiment shown, the whistling portion 40 also includes an outer flange 66, extending downwardly from the upper section 42a of the side wall 42, substantially parallel and spaced apart from the lower section 42b of the side wall 42. One skilled in the art will understand that, in an alternative embodiment, the whistling portion 40 can be free of outer flange 66 or that the outer flange 66 could be positioned, sized and/or shaped differently than the outer flange of the embodiment shown. One skilled in the art will also understand that, in alternative embodiments (not shown), other designs of the whistling portion 40 could provide the sealing shoulder 64. For example and without being limitative, in an embodiment (not shown), the side wall 42 can be substantially straight, with an inner flange projecting inwardly from the bottom wall 44 (i.e. projecting into the inner cavity 46 of the whistling portion 40).

The whistling portion 40 also includes a hollow whistle receiving protrusion 48 extending inwardly from the bottom wall 44 (i.e. extending from the bottom wall and into the inner cavity 46). The hollow whistle receiving protrusion 48 is opened in the bottom wall 44 and has a hollow inner space 49 for receiving a whistle 50. The hollow inner space 49 is defined by a peripheral wall 52 and an upper wall 54, spaced apart from the bottom wall 44 of the whistling portion 40. The upper wall 54 has a whistling aperture 56 defined therein and extending through the wall 54. The whistling aperture 56 allows fluid communication between the inner cavity 46 of the whistling portion 40 of the drinking container 10 and the hollow inner space 49 of the whistle receiving protrusion 48 in which the whistle 50 is placed. In an embodiment, the whistle 50 can be integral to the whistling portion 40 (i.e. the whistling portion 40 can be manufactured with a whistle 50 integrated thereto and positioned in the hollow inner space 49 of the whistle receiving protrusion 48). One skilled in the art will understand that, in alternative embodiments, the whistle 50 can also be an independent component mounted (removably or permanently) to the whistling portion, in the hollow inner space 49 of the whistle receiving protrusion 48 thereof, for example by screwing, gluing, press fit or the like. In another alternative embodiment, the drinking container 10 could include a plurality of whistles removably mountable into the hollow inner space 49 of the whistle receiving protrusion 48 and each making a different sound when activated, the user therefore being able to mount the whistle 50 producing the desired sound to the whistling portion 40.

In the embodiment shown, the whistling portion 40 also includes a perforation assembly 57 allowing perforation of the bottom wall section 26 of the unitary wall 21 of the main portion 20, to unseal the bottom section of the liquid receiving cavity 22, when the drinking container 10 is configured in the whistling configuration, as will be described in more details below. In the embodiment shown, the perforation assembly 57 includes a cutting member 58 extending from the upper wall 54 of the whistle receiving protrusion 48, into the inner cavity 46 and a spreading flange 60 also extending from the upper wall 54 of the whistle receiving protrusion 48, along a periphery of the whistling aperture 56. As will be described in more details below, the spreading flange 60 is configured to cooperate with the cutting member 58 to create an aperture in the bottom wall section 26 of the unitary wall 21 of the main portion 20 when the drinking container 10 is moved into the whistling configuration and therefore unseal the bottom section of the liquid receiving cavity 22 to allow fluid communications between the liquid receiving cavity 22 and the whistle 50 mounted to the whistling portion 40 of the drinking container 10. In the embodiment shown, the spreading flange 60 tapers towards the cutting member to ease the spreading of the bottom wall section 26 of the unitary wall 21 of the main portion 20, as the aperture therein is created when the drinking container 10 is configured from the drinking configuration to the whistling configuration. In an embodiment, the cutting member 58 is made of a hard material, such as hard plastic, metal, or the like and includes a cutting edge 58a sharp enough to cut through the material of the bottom wall section 26 of the unitary wall 21 of the main portion 20.

In the embodiment shown, the whistling portion 40 also includes projections 62 projecting inwardly from an inner surface of the side wall 42 of the whistling portion 40. Each one of the projections 40 is engageable into a corresponding one of the guiding slots 30 defined in the lower section 24a of the peripheral wall section 24 of the unitary wall 21 of the main portion 20. Hence, in the embodiment shown, the combination of the guiding slots 30 and the projections 62 engageable therein together define the translation assembly 90. One skilled in the art will however understand that, in alternative embodiments, the translation assembly 90 could differ from the embodiment shown. For example and without being limitative, in an alternative embodiment (not shown), the guiding slots 30 could be defined in the inner surface of the side wall 42 of the whistling portion 40, with the projections 62 projecting from the outer surface of the peripheral wall section 24 of the unitary wall 21 of the main portion 20. In other alternative embodiments (not shown), the translation assembly 90 could include components different than the above described combination of guiding slots 30 and corresponding projections 62 inserted therein, such as, for example and without being limitative, complementary threads defined in the main portion 20 and the whistling portion 40.

As can be seen in FIGS. 1A to 5, the whistling portion 40 is mounted to the main portion 20. In the embodiment shown, the whistling portion 40 is mounted to the main portion 20 through insertion of a section of the main portion 20 in the inner cavity 46 of the whistling portion 40 and engagement of each one of the projections 62 projecting inwardly from the inner surface of the side wall 42 of the whistling portion 40 in the corresponding guiding slot 30 defined on the outer surface of the lower section 24a of the peripheral wall section 24 of the unitary wall 21 of the main portion 20. In an embodiment, the whistling portion 40 is sized and shaped to minimize friction between the outer surface of the lower section 24a of the peripheral wall section 24 of the unitary wall 21 of the main portion 20 and the inner surface of the side wall 42 of the whistling portion 40 (i.e. the diameter of the inner cavity 46 of the whistling portion 40 is designed to substantially prevent friction therebetween).

In an embodiment, the whistling portion 40 is permanently mounted to the main portion (i.e. the whistling portion 40 cannot be dismounted from the main portion 20), thereby preventing exposure of the cutting member 58 and the associated injury risks to users. In other words, in an embodiment, excessive force (i.e. substantially more than the conventionally requested force to move the drinking container 10 between the drinking configuration and the whistling configuration and vice-versa), resulting in dismantling of the drinking container 10, is required to detach the whistling portion 40 from the main portion 20.

FIGS. 1A to 1C and 2 show the drinking container 10 in the drinking configuration. In the drinking configuration, the liquid receiving cavity 22 of the main portion 20 is unperforated (i.e. the bottom wall section 26 of the unitary wall 21 of the main portion 20 is unperforated and the lower section of the liquid receiving cavity 22 is therefore sealed to prevent fluid communication between the liquid receiving cavity 22 and the whistle 50) and the drinking container 10 can be used as a conventional container to hold the liquid, while the user drinks the liquid. In the embodiment shown, in the drinking configuration, the whistling portion 40 is positioned relative to the main portion 20, such that the perforation assembly 57 is spaced apart from the unperforated bottom wall section 26 of the unitary wall 21 of the main portion 20.

In an embodiment, in order to prevent undesired user induced transition of the drinking container 10 from the drinking configuration to the whistling configuration, the drinking container 10 includes a security tab 70. In the embodiment shown, the security tab 70 is removably mounted on an outer surface of the drinking container 10, between an upper edge of the side wall 42 of the whistling portion 40 and the abutment shoulder 32 of the peripheral wall section 24 of the unitary wall 21 of the main portion 20. When secured to the drinking container 10, the security tab 70 prevents upward movement of the whistling portion 40 towards the main portion 20 (i.e. prevents translation of the drinking container 10 between the drinking configuration and the whistling configuration). The security tab 70, is removable to allow the translation of the drinking container 10 between the drinking configuration and the whistling configuration, once removed. One skilled in the art will understand that, in an alternative embodiment, the security tab 70 could differ from the security tab of the embodiment shown, while still preventing undesired user induced transition of the drinking container 10 from the drinking configuration to the whistling configuration. For example and without being limitative, the security tab 70 could be a pressable or pullable tab, selectively pushed or pulled to allow the transition of the drinking container 10 from the drinking configuration to the whistling configuration. Moreover, it will be understood that, in other alternative embodiments (not shown), other mechanisms different from a security tab could also be used to prevent undesired user induced transition of the drinking container 10 from the drinking configuration to the whistling configuration.

In view of the above, in an embodiment, once the user has emptied the liquid receiving cavity 22 of the main portion 20 of the drinking container 10 from its content, the drinking container 10 can be transitioned from the drinking configuration to the whistling configuration. In the embodiment shown, to allow the transition from the drinking configuration to the whistling configuration, the security tab 70 is removed (or peeled off) from the drinking container 10 (see FIGS. 1B and 1C), thereby creating a space between the upper edge of the side wall 42 of the whistling portion 40 and the abutment shoulder 32 of the peripheral wall section 24 of the unitary wall 21 of the main portion 20, to allow upward movement (or translation) of the whistling portion 40 relative to the main portion 20.

Referring to FIGS. 3 to 5, once the security tab 70 has been removed, in an embodiment, the whistling portion 40 can be rotated relative to the main portion 20, to move the whistling portion 40 upwardly and towards the main portion 20. In the embodiment shown, when the whistling portion 40 is rotated relative to the main portion 20, the projections 62 of the whistling portion 40 are displaced along the guiding slots 30 of the main portion 20 (i.e. between the lower end 30a thereof and the upper end 30b thereof), thereby driving the whistling portion 40 towards the main portion 20, as a result of the upward angle of the guiding slots 30.

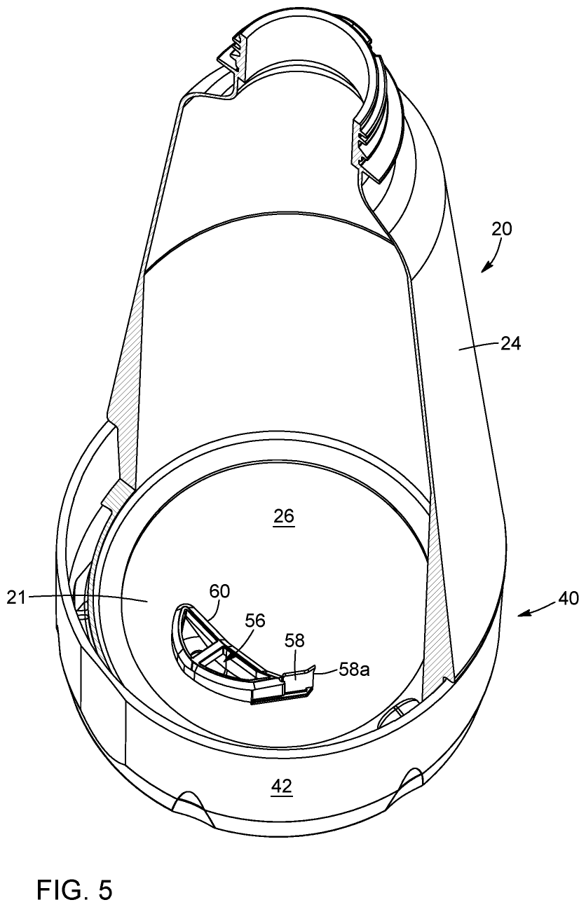

As the whistling portion 40 is driven towards the main portion 20, the perforation assembly 57 engages the bottom wall section 26 of the unitary wall 21 of the main portion 20 and perforates the bottom wall section 26, thereby unsealing the bottom section of the liquid receiving cavity and allowing fluid communication between the liquid receiving cavity 22 and the whistle 50 mounted in the hollow inner space 49 of the whistle receiving protrusion 48, through the whistling aperture 56. In more details, in the embodiment shown, when the whistling portion 40 is driven towards the main portion 20, the cutting member 58 of the perforation assembly 57 begins engaging the bottom wall section 26 of the unitary wall 21 of the main portion 20 and creates a small aperture therein. Subsequently, as the whistling portion 40 is further rotated, the cutting member 58 continuously cuts the bottom wall section 26 of the unitary wall 21 of the main portion 20, and the tapered end of the spreading flange 60 spreads the bottom wall section 26 open and maintains the sections of the bottom wall section 26 away from the whistling aperture 56, as the spreading flange 60 is driven through the bottom wall section 26 of the unitary wall 21 of the main portion 20 and inside the liquid receiving cavity 22 (see FIG. 5). Therefore, the whistling aperture 56 is opened in the liquid receiving cavity 22 and allows fluid communication between the liquid receiving cavity 22 and the whistle 50 mounted in the hollow inner space 49 of the whistle receiving protrusion 48.

In view of the above, once the content of the drinking container has been consumed and the drinking container 10 is configured in the whistling configuration, the drinking container 10 can be used as a whistling device. Indeed, to use the drinking container 10 as a whistling device, a user can simply blow in the liquid receiving cavity 22 of the main portion 20 (through the bottleneck 28) in order to activate the whistle 50 located in the hollow inner space 49 of the whistle receiving protrusion 48 of the whistling portion 40.

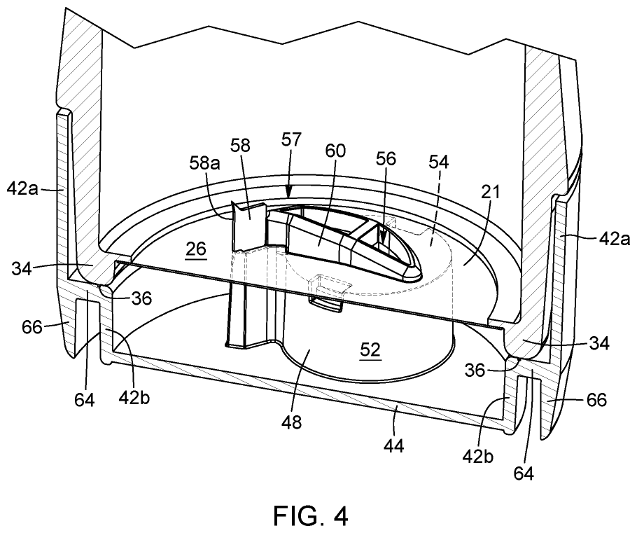

In an embodiment, and as better seen in FIG. 4, the drinking container includes a sealing assembly preventing air blown into the liquid receiving cavity 22 of the main portion 20 (for example by a user blowing in the bottleneck 28) from leaking out of the drinking container 10 through a space between the main portion 20 and the whistling portion 40, when the drinking container 10 is configured in the whistling configuration. In view of the above, in the embodiment shown, air blown into the liquid receiving cavity 22 of the main portion 20 is substantially entirely expelled through the hollow inner space 49 of the whistle receiving protrusion 48 of the whistling portion 40, where it activates the whistle 50 located therein.

In the embodiment shown, the sealing assembly is provided by the lower flange 34 of the main portion 20 being abutted against the surface of the sealing shoulder 64 of the whistling portion 40 and the sealing member 36 of the lower flange 34 of the main portion 20 being pressed against the sealing shoulder 64 of the whistling portion 40. One skilled in the art will however understand that, in alternative embodiments (not shown), other assemblies could be provided for sealing a portion of the inner cavity 46 of the whistling portion 40. For example and without being limitative, in an embodiment (not shown) a sealing member (not shown) can extend from the sealing shoulder 64 rather than from the lower flange 34.

In the embodiment shown, the main portion 20 also includes a stop member 31 extending into each one of the guiding slots 30, proximate to the upper end 30b thereof. The stop member 31 includes a leading wall 31a and a stop wall 31b. The leading wall 31a defines a small angle relative to the lower wall 30c of the guiding slot 30 to allow the projection 62 of the whistling portion 40 to move past the stop member 31 when the whistling portion 40 is rotated to configure the drinking container 10 in the whistling configuration. The stop wall 31b extends substantially perpendicular to the lower wall 30c of the guiding slot 30, thereby creating a shoulder preventing backward movement of the projection 62 of the whistling portion 40 in the guiding slot 30, once the projection 62 has moved past the stop member 31. In view of the above, in the embodiment shown, the whistling portion 40 can only be rotated between the drinking configuration and the whistling configuration (for example in a clockwise direction) and cannot return to the drinking configuration once the whistling configuration has been reached. One skilled in the art will understand that, in alternative embodiments (not shown), other assemblies preventing the drinking container 10 from being brought back to the drinking configuration once the whistling configuration is reached could be provided. Moreover, in an alternative embodiment, the drinking container 10 could be free of assemblies preventing the drinking container 10 from being brought back to the drinking configuration once the whistling configuration is reached

In the embodiment shown, the main portion 20 and the whistling portion 40 are made of plastic, but one skilled in the art will understand that, in alternative embodiments, other materials offering sufficient rigidity can be used. For example and without being limitative, in an embodiment, the main portion 20 and/or the whistling portion 40 can be made of aluminum. One skilled in the art will understand that the main portion 20 and the whistling portion 40 and/or other sections thereof can be made of different materials (i.e. in an embodiment a plurality of different materials can be used for the main portion 20 and/or the whistling portion 40).

Now referring to FIGS. 8 to 11, as mentioned above, there is shown an alternative embodiment of the drinking container 110 wherein similar features are numbered using the same reference numerals in the 100 series.

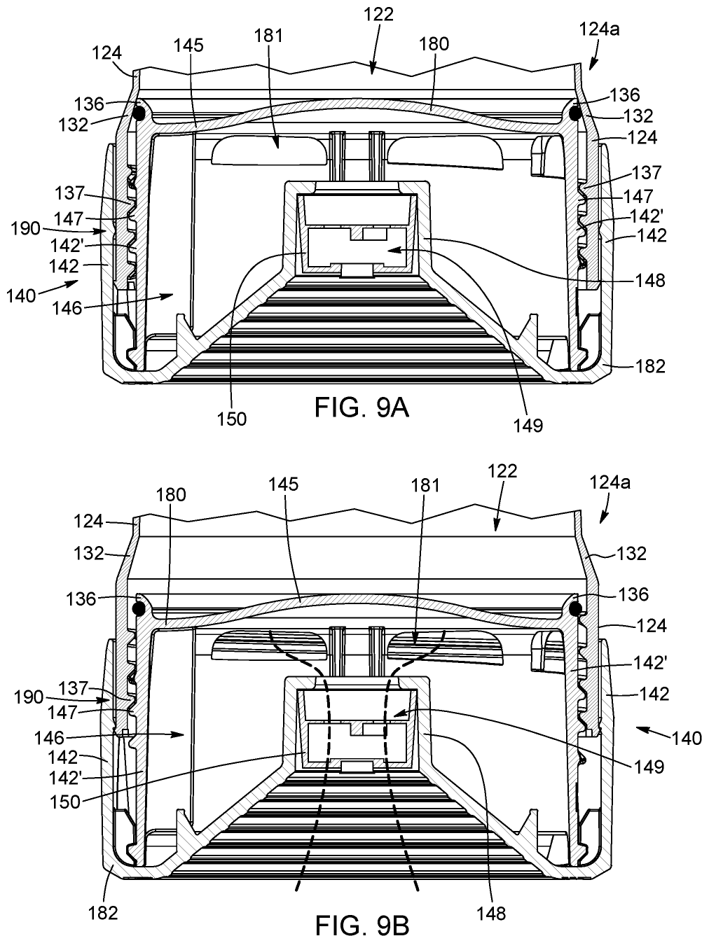

In the embodiment shown in FIGS. 8 to 11, once again the drinking container 110 includes a main portion 120 and a whistling portion 140 positioned below the main portion 120 and operatively connected therewith, with the whistling portion 140 being translatable relative to the main portion 120 to move the drinking container 110 between the drinking configuration (see FIG. 9A) and the whistling configuration (see FIG. 9B), as will be described in more details below.

The main portion 120 again defines a liquid receiving cavity 122 and has a peripheral wall section 124, and a closeable upper end 127 having a bottleneck 128 with an upper opening 129 at an upper end thereof. Once again, in the embodiment shown, the bottleneck 128 has a threaded outer surface allowing a removable threaded screw cap (not shown) to be screwed onto the drinking container 110 to close the liquid receiving cavity 122 and prevent the liquid contained therein to leak out of the liquid receiving cavity 122 through the upper opening 129. Similar to the first embodiment described above, once again it will be understood that the upper opening 129 of the bottleneck 128 could also be closed by a closing member different from a screw cap or the closeable upper end 127 could include an assembly different than the above described bottleneck and screw cap for temporarily closing the liquid receiving cavity 122.

In the embodiment of FIGS. 8 to 11, the main portion 120 is open at the lower end 124a of the peripheral wall section 124. As will be described in more details below, when the drinking container is configured in the drinking configuration (see FIG. 9A), an upper wall 145 of the whistling portion 140 is operatively engaged to the peripheral wall section 124, to seal the bottom section of the liquid receiving cavity 122 and thereby prevent fluid communication between the liquid receiving cavity 122 and the whistle 50. To seal the bottom section of the liquid receiving cavity 122 using the upper wall 145 of the whistling portion 140, in the embodiment shown, the lower section 124a of the peripheral wall section 124 of the main portion 120 expands outwardly to define an abutment shoulder 132 at an upper end of the lower section 124a and the open-ended lower section 124a of the peripheral wall section 124 is operatively engageable with the whistling portion 140 to seal the liquid receiving cavity by abutting a section of the whistling portion 140 onto the abutment shoulder 132 of the peripheral wall section 124, as will be described in more details below.

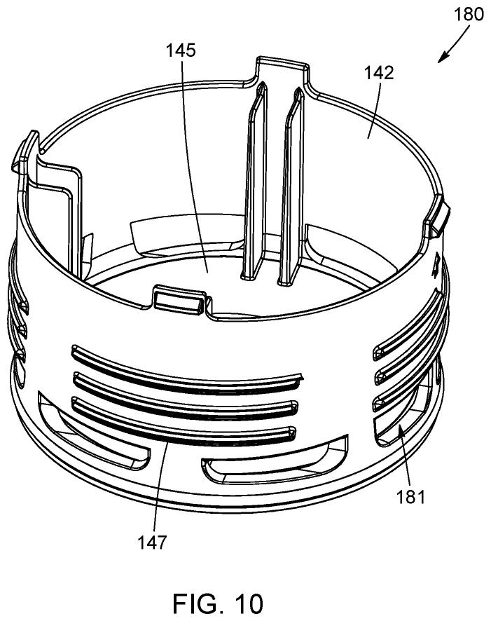

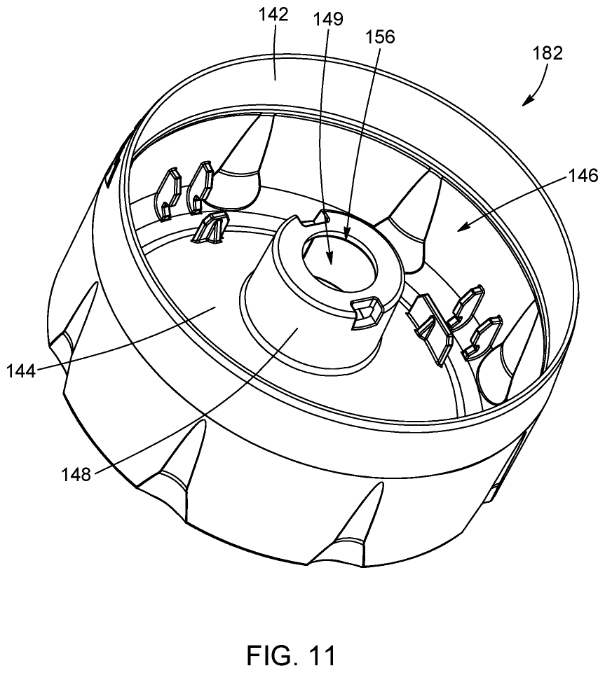

In the embodiment shown in FIGS. 8 to 11, the whistling portion 140 of the drinking container 110 includes an inner section 180 (see FIG. 10) and an outer section 182 (see FIG. 11) engageable to one another to define the whistling portion 140. In an embodiment, the inner section 180 and the outer section 182 are engageable to one another in a press-fit configuration, but one skilled in the art will understand that, in an alternative embodiment (not shown), the inner section 180 and the outer section 182 could be integral (or unitary).

The outer section 182 includes a side wall 142 (or whistling portion outer section side wall) and a bottom wall 144, thereby defining an inner cavity 146. The top section of the side wall 142 of the outer section 182 is substantially sealed against the lower section 124a of the peripheral wall section 124 of the main portion 120, as the side wall 142 of the outer section 182 extends over and abuts against the lower section 124a of the peripheral wall section 124 of the main portion 120. The outer section 182 of the whistling portion 140 also includes a hollow whistle receiving protrusion 148 extending inwardly from the bottom wall 144, into the inner cavity 146, for receiving a whistle 150. The whistle receiving protrusion 148 has a whistling aperture 156 allowing fluid communication between the inner cavity 146 and a hollow inner space 149 of the whistle receiving protrusion 148 in which the whistle 150 is received.

The inner section 180 of the whistling portion 140 (shown in an inverted position in FIG. 10 to better show the components thereof) includes a side wall 142′ (or whistling portion inner section side wall) and an upper wall 145. The inner section 180 of the whistling portion 140 also includes a sealing member 136 projecting from a periphery of the upper wall 145. Once again, in the embodiment shown, the sealing member 136 is a projection extending upwardly from the upper wall 145 of the inner section 180 of the whistling portion 140 and made of the same material as the remaining components of the whistling portion 140. Once again, it will however be understood that, in an alternative embodiment (not shown), the sealing member 136 could be made of resilient material, such as rubber, in order to offer high sealing properties when abutted against a rigid surface. The inner section 180 of the whistling portion 140 further includes through holes 181 extending through the side wall 142′ of the inner section.

In the embodiment of FIGS. 8 to 11, the translation assembly 190 includes a combination of threads 137 on an inner surface of the lower section 124a of the peripheral wall section 124 and complementary threads 147 on the outer surface of the side wall 142′ of the inner section 180. The threads 137, 147 are engageable to allow the translation of the whistling portion 140 relative to the main portion 120 when the drinking container 110 is moved from the drinking configuration to the whistling configuration, as will be described in more details below. One skilled in the art will understand that, in an alternative embodiment (not shown), a different translation assembly 190, such as, for example and without being limitative, a combination of guiding slots and corresponding projections, as described in connection to the first embodiment, could be used rather than the above-described complementary threads 137, 147.

As can be seen in FIGS. 9A and 9B, the whistling portion 140 is mounted to the main portion 120. In the embodiment shown, the whistling portion 140 is mounted to the main portion 120 through the lower section 124a of the peripheral wall section 124 of the main portion 120 being inserted between the side wall 142′ of the inner section 180 and the side wall 142 of the outer section 182 of the whistling portion 140 and the threads 137 of the of the peripheral wall section 124 of the main portion 120 engaging the threads 147 of the inner section 180 of the whistling portion 140.

FIG. 9A shows the drinking container 110 in the drinking configuration. In the drinking configuration, the bottom section of the liquid receiving cavity 122 of the main portion 120 is sealed (or closed) by the combination of the upper wall 145 of the inner section 180 of the whistling portion 140 extending in the aperture defined at the lower end 124a of the peripheral wall section 124 and the sealing member 136 of the inner section 180 of the whistling portion 140 being pressed against the abutment shoulder 132 of the main portion 120 to seal the whistling portion 140 against the peripheral wall section 124 of the main section 120. Therefore, in the drinking configuration, the drinking container 110 can be used as a conventional container to hold the liquid in the liquid receiving cavity 122, while the user drinks the liquid. One skilled in the art will understand that, in alternative embodiments (not shown), the main portion 120 and the whistling portion 140 could be sized and shaped differently than in the embodiment shown, with the liquid receiving cavity 122 of the main portion 120 being closed at a bottom end by the upper wall 145 of the inner section 180 of the whistling portion 140 in engagement with a section of the main portion 120, to seal the bottom section of the liquid receiving cavity 122 and therefore prevent fluid communication between the liquid receiving cavity 122 and the whistle 150. For example and without being limitative, in an embodiment (not shown), a projection could extend from the main portion 120 to abut against the whistling portion 140 and seal the liquid receiving cavity 122 when the drinking container 110 is configured in the drinking configuration.

In the embodiment shown, to transition the drinking container 110 from the drinking configuration to the whistling configuration, the whistling portion 140 can be rotated relative to the main portion 120, to move the whistling portion 140 away from the main portion 120 (as they move along the complementary threads 137, 147), thereby creating a space between the sealing member 136 of the inner section 180 and the abutment shoulder 132 of the main portion 120 and unsealing the lower section of the liquid receiving cavity 122 (see FIG. 9B showing the drinking container 110 in the whistling configuration). As can be seen in FIG. 9B, the space created between the sealing member 136 of the inner section 180 and the abutment shoulder 132 of the main portion 120 results in disengagement of the upper wall 145 if the whistling portion 145 from the peripheral wall section 124 and allows fluid communication between the liquid receiving cavity 122 and the whistle 150 placed in the hollow inner space 149 of the whistle receiving protrusion 148, as air can move between the peripheral wall 124 of the main portion 120 and the inner section 180 of the whistling portion, through the through holes 181 defined in the side wall 142′ of the inner section 180 of the whistling portion 140, and finally through the whistling aperture 156, to reach the whistle 150 placed in the hollow inner space 149 of the whistle receiving protrusion 148.

As can be seen in FIG. 9B, when the drinking container 110 is configured in the whistling configuration, the main portion 120 and the drinking portion 140 are configured to prevent air blown into the liquid receiving cavity 122 of the main portion 120 (for example by a user blowing in the bottleneck 128) from leaking out of the drinking container 110 through a space between the main portion 120 and the whistling portion 140. In other words, the main portion 120 and the whistling portion 140 are sealed against one another, such that the air blown in the liquid receiving cavity 122 is substantially entirely expelled through the whistling aperture 156, to reach the whistle 150 placed in the hollow inner space 149 of the whistle receiving protrusion 148.

In the embodiment shown in FIGS. 8 to 11, no security tab is provided to prevent undesired user induced transition of the drinking container 110 from the drinking configuration to the whistling configuration. One skilled in the art will however understand that, in an alternative embodiment (not shown), a security tab could be provided. For example and without being limitative, the security tab could be a security tab removably mounted on an outer surface of the drinking container 110 (for example similarly to the security tab shown in FIG. 1A) or any other type of removable or movable component preventing accidental translation of the whistling portion 140 relative to the main portion 120.

In the embodiment shown in FIGS. 8 to 11, the whistling portion 140 is moveable relative to the main portion 120, to configure the drinking container 120 between the drinking configuration (see FIG. 9A) and the drinking configuration (see FIG. 9B) and vice-versa. In other words, the drinking container 120 can be repeatedly moved between the drinking configuration (where it can be used to hold a liquid in the liquid receiving cavity 122) and the drinking configuration (where it can be used to produce a whistling sound). Hence, the drinking container 110 can be repeatedly reused to hold a liquid, even after being moved to the whistling configuration, thereby providing an eco-friendly reusable drinking container 110.

The drinking container 10, 110 convertible into a whistling device, in accordance with the first embodiment shown in FIGS. 1A to 7B and the second embodiment shown in FIGS. 8 to 11, having been described above, an embodiment of a method for configuring the drinking container 10, 110 between the drinking configuration and the whistling configuration will now be described in more details below.

In an embodiment, the drinking container is initially configured in the drinking configuration, with a section of the liquid receiving cavity of the main portion of the drinking container being sealed to prevent fluid communication between the liquid receiving cavity and a whistle and allow the liquid receiving cavity to hold a liquid to be drunk by a user. As a first step, the drinking container is emptied of its content, for example by the user drinking the liquid contained in the liquid receiving cavity of the main portion of the drinking container. Once the drinking container is emptied of its content, the method includes translating the whistling portion of the drinking container relative to the main portion until the section of the liquid receiving cavity is unsealed and the liquid receiving cavity of the main portion and the whistle are in fluid communication.

In an embodiment (See FIGS. 1A to 7B), the whistle is located in a hollow inner space of a whistle receiving protrusion of the whistling portion and the whistling portion of the drinking container is translated towards the main portion until the liquid receiving cavity of the main portion and the hollow inner space of the whistle receiving protrusion of the whistling portion are in fluid communication. In such an embodiment, such fluid communication can be achieved by a cutting member of a perforation assembly of the whistling portion perforating a previously unpunctured bottom section wall of a unitary wall of the main portion of the fluid container, to allow fluid communication through a whistling aperture of the whistle receiving protrusion.

In an alternative embodiment (See FIGS. 8 to 11), the whistle is again located in a hollow inner space of a whistle receiving protrusion of the whistling portion and the whistling portion of the drinking container is translated away from the main portion until the liquid receiving cavity of the main portion and the hollow inner space of the whistle receiving protrusion of the whistling portion are in fluid communication. In such an embodiment, such fluid communication is achieved by disengaging the upper wall of the whistling portion from the peripheral wall to unseal the corresponding section of the liquid receiving cavity (the upper wall of the whistling portion being initially operatively engaged to the peripheral wall of the main portion to seal the section of the liquid receiving cavity as the drinking container is configured in the drinking configuration). In more details, in an embodiment, the fluid communication between the liquid receiving cavity of the main portion and the hollow inner space of the whistle receiving protrusion of the whistling portion is achieved by a sealing member extending along a periphery of the upper wall of the whistling portion being spaced apart from an abutment shoulder of a peripheral wall of the main portion to unseal the liquid receiving cavity and to allow fluid communication via through holes defined in a peripheral wall of an inner section of the whistling portion and into an inner cavity thereof, the whistle receiving protrusion including a whistling aperture open in the inner cavity of the whistling portion.

In the embodiments shown, the translation of the whistling portion of the drinking container relative to the main portion is performed by rotating the whistling portion relative to the main portion, but one skilled in the art will understand that, in an alternative embodiment, the translation can be performed through a different translation movement.

Several alternative embodiments and examples have been described and illustrated herein. The embodiments of the invention described above are intended to be exemplary only. A person skilled in the art would appreciate the features of the individual embodiments, and the possible combinations and variations of the components. A person skilled in the art would further appreciate that any of the embodiments could be provided in any combination with the other embodiments disclosed herein. It is understood that the invention may be embodied in other specific forms without departing from the central characteristics thereof. The present examples and embodiments, therefore, are to be considered in all respects as illustrative and not restrictive, and the invention is not to be limited to the details given herein. Accordingly, while specific embodiments have been illustrated and described, numerous modifications come to mind without significantly departing from the scope of the invention as defined in the appended claims.

We claim:

1. A drinking container configurable between a drinking configuration and a whistling configuration, the drinking container comprising:
a main portion defining a liquid receiving cavity; and
a whistling portion positioned below the main portion and operatively connected thereto, the whistling portion comprising a whistle and being translatable relative to the main portion to configure the drinking container between the drinking configuration and the whistling configuration;
wherein, when the drinking container is configured in the drinking configuration, a section of the liquid receiving cavity is sealed and prevents fluid communication between the liquid receiving cavity and the whistle while allowing the liquid receiving cavity to hold a liquid therein, and when the drinking container is configured in the whistling configuration, the section of the liquid receiving cavity is unsealed and allows fluid communication between the liquid receiving cavity and the whistle.

2. The drinking container of claim 1, wherein the drinking container includes a translation assembly configured to allow the translation of the whistling portion relative to the main portion, for transitioning the drinking container between the drinking configuration and the whistling configuration, the whistling portion being rotatably mounted to the main portion and the whistling portion being translatable to configure the drinking container between the drinking configuration and the whistling configuration by a rotation thereof relative to the main portion, the main portion and whistling portion including complementary threads to allow rotation between the main portion and the whistling portion.

3. (canceled)

4. The drinking container of claim 2, wherein one of the main portion and the whistling portion comprises at least one elongated guiding slot, and the other one of the main portion and the whistling portion comprises at least one projection engageable in a corresponding one of the at least one guiding slot to allow rotation between the main portion and the whistling portion.

5. (canceled)

6. The drinking container of claim 1, wherein the drinking container further comprises a security tab selectively preventing translation of the whistling portion relative to the main portion and thereby selectively preventing the drinking container from being moved from the drinking configuration to the whistling configuration.

7. The drinking container of claim 1, wherein the main portion comprises a peripheral wall section being open at a lower end thereof and wherein the whistling portion comprises an upper wall and a sealing member, the sealing member projecting from the upper wall of the whistling portion, at a periphery thereof, and being pressed against the peripheral wall section of the main portion to seal the section of the liquid receiving cavity using the upper wall of the whistling portion, when the drinking container is configured in the drinking configuration.

8. (canceled)

9. The drinking container of claim 7, wherein the whistling portion is translatable away from the main portion to space the sealing member from the peripheral wall section of the main portion and unseal the liquid receiving cavity to configure the drinking container in the whistling configuration.

10. The drinking container of claim 9, wherein the peripheral wall section of the main portion comprises an abutment shoulder and wherein the sealing member of the whistling portion is pressed against the abutment shoulder of the peripheral wall section of the main portion, when the drinking container is configured in the drinking configuration.

11. The drinking container of claim 9, wherein the whistling portion comprises an outer section having a side wall engageable to a section of the peripheral wall section of the main portion and an inner section including the upper wall of the whistling portion and a side wall having at least one through hole extending therethrough and the outer section of the whistling portion comprises a whistle receiving protrusion having an upper wall with a whistling aperture defined therein and extending therethrough, the whistle receiving protrusion defining a hollow inner space for receiving the whistle, and wherein, when the drinking container is configured in the whistling configuration, the spacing of the sealing member apart from the peripheral wall section of the main portion allows fluid communication between the liquid receiving cavity and the hollow inner space of the whistle receiving protrusion.

12. (canceled)

13. The drinking container of claim 1, wherein the main portion comprises a unitary wall having an unperforated bottom wall section when the drinking container is configured in the drinking configuration and wherein the whistling portion engages the unperforated wall section of the main portion to perforate the bottom wall section of the main portion when the drinking container is configured in the drinking configuration.

14. The drinking container of claim 13 wherein the whistling portion comprises a perforation assembly and a whistle receiving protrusion having an upper wall with a whistling aperture defined therein and extending therethrough, the whistle receiving protrusion defining a hollow inner space for receiving the whistle and the perforation assembly comprising a cutting member extending from the upper wall of the whistle receiving protrusion and wherein, when the drinking container is configured in the whistling configuration, the perforation assembly perforates the unperforated wall section of the main portion and allows fluid communication between the liquid receiving cavity and the hollow inner space of the whistle receiving protrusion.

15. (canceled)

16. The drinking container of claim 14, wherein the perforation assembly comprises a spreading flange extending from the upper wall of the whistle receiving protrusion along a periphery of the whistling aperture.

17. The drinking container of claim 13, wherein the whistling portion comprises an inner cavity and a sealing shoulder extending in the inner cavity of the whistling portion, the sealing shoulder being abuttable against a surface of the main portion when the drinking container is configured in the whistling configuration to seal a section of the inner cavity of the whistling portion.

18. The drinking container of claim 17, wherein the main portion comprises a lower flange extending peripherally at the lower end thereof, the sealing shoulder being abuttable with a lower end of the lower flange when the drinking container is configured in the whistling configuration and at least one of the whistling portion and the main portion further comprises a resilient sealing member projecting from a corresponding one of the sealing shoulder and the lower flange.

19. (canceled)

20. A drinking container configurable between a drinking configuration and a whistling configuration, the drinking container comprising:
a main portion having a peripheral wall defining a liquid receiving cavity, the peripheral wall being open at a lower end thereof; and
a whistling portion positioned below the main portion and operatively connected thereto, the whistling portion comprising an upper wall operatively engaged to a section of the peripheral wall of the main portion to seal a lower section of the liquid receiving cavity and prevent fluid communication between the liquid receiving cavity and the whistle, when the drinking container is configured in the drinking configuration, and being disengaged from the section of the peripheral wall of the main portion to unseal the lower section of the liquid receiving cavity and allow fluid communication between the liquid receiving cavity and the whistle, when the drinking container is configured in the whistling configuration.

21. The drinking container of claim 20, wherein the drinking container includes a translation assembly configured to allow the translation of the whistling portion relative to the main portion, for transitioning the drinking container between the drinking configuration and the whistling configuration, the whistling portion being rotatably mounted to the main portion and being translatable to configure the drinking container between the drinking configuration and the whistling configuration by a rotation thereof relative to the main portion, the main portion and whistling portion including complementary threads to allow rotation between the main portion and the whistling portion.

22. (canceled)

23. The drinking container of claim 21, wherein one of the main portion and the whistling portion comprises at least one elongated guiding slot, and the other one of the main portion and the whistling portion comprises at least one projection engageable in a corresponding one of the at least one guiding slot to allow rotation between the main portion and the whistling portion.

24. (canceled)

25. The drinking container of claim 20, wherein the whistling portion includes a sealing member projecting from the upper wall of the whistling portion, at a periphery thereof, the sealing member being pressed against the section of the peripheral wall of the main portion to operatively engage the upper wall of the whistling portion with the section of the peripheral wall of the main portion and seal the lower section of the liquid receiving cavity, when the drinking container is configured in the drinking configuration.

26. The drinking container of claim 25, wherein the whistling portion is translatable away from the main portion to space the sealing member from the section of the peripheral wall of the main portion and unseal the lower section of the liquid receiving cavity to configure the drinking container in the whistling configuration.

27. The drinking container of claim 26, wherein the section of the peripheral wall of the main portion comprises an abutment shoulder and wherein the sealing member of the whistling portion is pressed against the abutment shoulder of the section of the peripheral wall of the main portion, when the drinking container is configured in the drinking configuration.

28. The drinking container of claim 26, wherein the whistling portion comprises an outer section having a peripheral wall engageable to the peripheral wall of the main portion and an inner section including the upper wall of the whistling portion and a side wall having at least one through hole extending therethrough and the outer section of the whistling portion comprises a whistle receiving protrusion having an upper wall with a whistling aperture defined therein and extending therethrough, the whistle receiving protrusion defining a hollow inner space for receiving the whistle, and wherein, when the drinking container is configured in the whistling configuration, the spacing of the sealing member apart from the section of the peripheral wall of the main portion allows fluid communication between the liquid receiving cavity and the hollow inner space of the whistle receiving protrusion.

29. (canceled)

30. A method for configuring a drinking container between a drinking configuration and a whistling configuration, the drinking container having a main portion sized and shaped to define a liquid receiving cavity and a whistling portion including a whistle and operatively connected to the main portion, the method comprising:
receiving the drinking container in the drinking configuration wherein a section of the liquid receiving cavity is sealed to prevent fluid communication between the liquid receiving cavity and the whistle and to allow the liquid receiving cavity to hold a liquid;
emptying the liquid from the liquid receiving cavity of the main portion of the drinking container; and
translating the whistling portion relative to the main portion until the section of the liquid receiving cavity is unsealed and the main portion and the whistle of the whistling portion are in fluid communication.

31. The method of claim 30, wherein the step of translating the whistling portion relative to the main portion comprises rotating the whistling portion relative to the main portion.

32. The method of claim 30, wherein the whistling portion comprises an upper wall operatively engaged to a peripheral wall of the main portion to seal the section of the liquid receiving cavity when the drinking container is configured in the drinking configuration and wherein the step of translating the whistling portion relative to the main portion until the liquid receiving cavity is unsealed further comprises disengaging the upper wall from the peripheral wall to unseal the corresponding section of the liquid receiving cavity.

33. The method of claim 30, wherein the main portion comprises a unitary wall having an unperforated lower wall section and the whistling portion includes a perforation assembly and a whistle receiving protrusion having an upper wall with a whistling aperture defined therein and extending therethrough, the whistle receiving protrusion defining a hollow inner space for receiving the whistle, and the step of translating the whistling portion relative to the main portion until the liquid receiving cavity is unsealed further comprises perforating the unperforated lower wall section of the main portion to allow fluid communication between the liquid receiving cavity and the hollow inner space of the whistle receiving protrusion.
